(19) United States
(12) Patent Application Publication
(10) Pub. No.: US 2012/0101819 A1
(43) Pub. Date: Apr. 26, 2012

(54) SYSTEM AND A METHOD FOR PROVIDING SOUND SIGNALS

(75) Inventors: Arie Heiman, Ra'anana (IL); Uri Yehuday, Bat Yam (IL)

(73) Assignee: BONETONE COMMUNICATIONS LTD., Rosh Ha’ayin (IL)

(21) Appl. No.: 13/380,920

(22) PCT Filed: Jun. 30, 2010
(86) PCT No.: PCT/IL10/00525

§ 371 Date: Dec. 27, 2011

(51) Int. Cl. G10L 15/20; H04R 1/10

(52) U.S. Cl. 704/233; 381/74; 704/E15.039

(57) ABSTRACT

A sound system, the sound system including: (i) a processor, configured to: (a) receive a requested sound signal and an ambient sound input signal; and (b) generate a modified requested signal by processing, in response to a desired level of ambient sound that is defined by a user, the requested sound signal and the ambient sound input signal, wherein an inclusion level of the ambient sound input signal in the modified requested signal is responsive to the desired level of ambient sound; and (ii) a signal provider configured to provide the modified requested signal to multiple speakers of a headset.

### RELATED APPLICATIONS

This application claims priority from U.S. provisional patent application Ser. No. 61/222,526 filing date Jul. 2, 2009 which is incorporated herein by its entirety.

### BACKGROUND OF THE INVENTION

Today mobile music devices such as media player or mobile phones provides high quality music, users use it “on the go” and in any other places. In more advanced mobile devices the user can also watch high quality movies or TV programs. Such devices are provided by many vendors such as Apple, Microsoft, and SanDisk.

In order to enhance the listening experience many vendors provide headsets that decrease the ambient sound. Some use “in ear” headset while other vendors use headset that close the pinna in order to block the ambient sound, some headset add some techniques of noise cancellation to further reduce the ambient noise for the listener. In some other cases users hear the music in very high volume.

In all those above disclosed prior art solution, the user are partially “disconnected” from the external world and almost does not hear the external world sounds. In some cases this can be very dangerous as the user may not aware what is happening in his surround.

There is therefore a need to provide a sound system that enables control over the level of ambient sound.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A illustrates a sound system, according to an embodiment of the invention;

FIG. 1B illustrates a sound system incorporated into a headset, according to an embodiment of the invention;

FIG. 1C illustrates a sound system incorporated into a cellular phone, according to an embodiment of the invention;

FIG. 2 illustrates a method for providing a sound signal, according to an embodiment of the invention;

FIGS. 3, 4, and 5 illustrate various sound systems, according to various embodiments of the invention; and

FIG. 6 illustrates a flowchart of a method for modifying an inclusion level of the ambient sound input signal in response to a detected state of at least one of the ambient sound input signal and the requested sound signal, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY OF THE INVENTION

A sound system, the sound system including: (i) a processor, configured to: (a) receive a requested sound signal and an ambient sound input signal; and (b) generate a modified requested signal by processing, in response to a desired level of ambient sound that is defined by a user, the requested sound signal and the ambient sound input signal, wherein an inclusion level of the ambient sound input signal in the modified requested signal is responsive to the desired level of ambient sound; and (ii) a signal provider configured to provide the modified requested signal to multiple speakers of a headset.

A method for providing a sound signal, the method including: (i) receiving a requested sound signal and an ambient sound input signal; (ii) generating a modified requested signal by processing, in response to a desired level of ambient sound that is defined by a user, the requested sound signal and the ambient sound input signal, wherein an inclusion level of the ambient sound input signal in the modified requested signal is responsive to the desired level of ambient sound; and (iii) providing the modified requested signal to at least one speaker of a headset.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

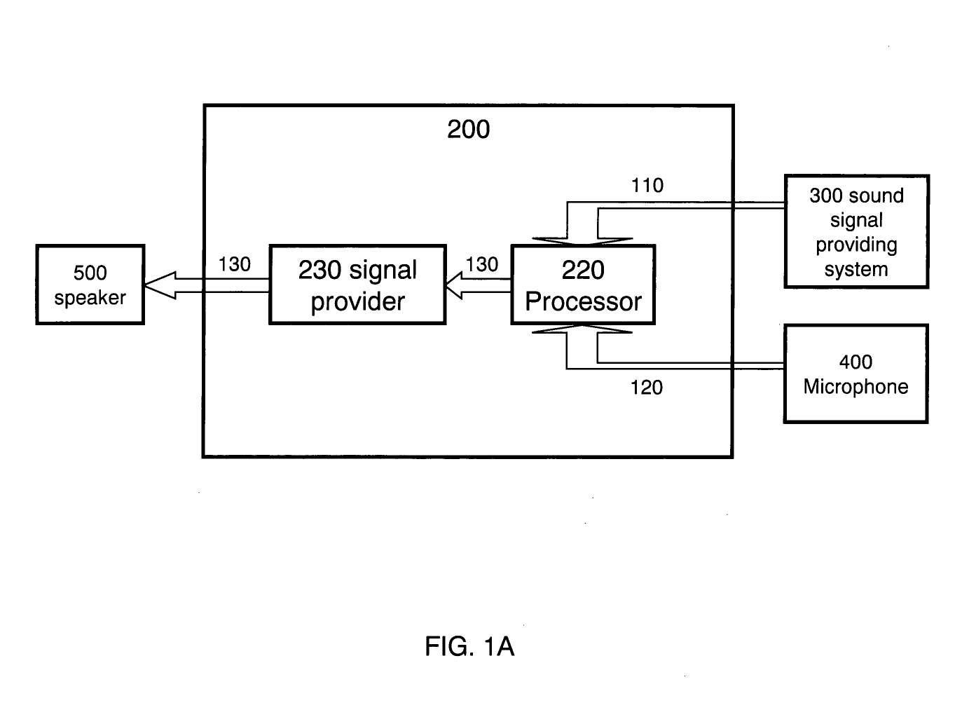

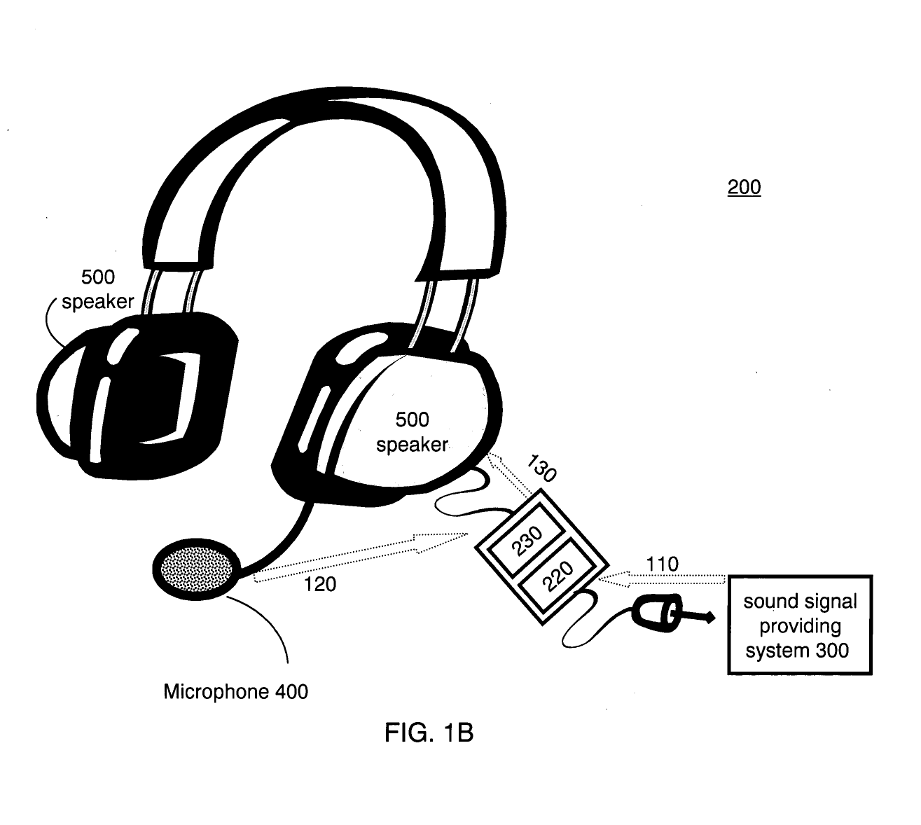

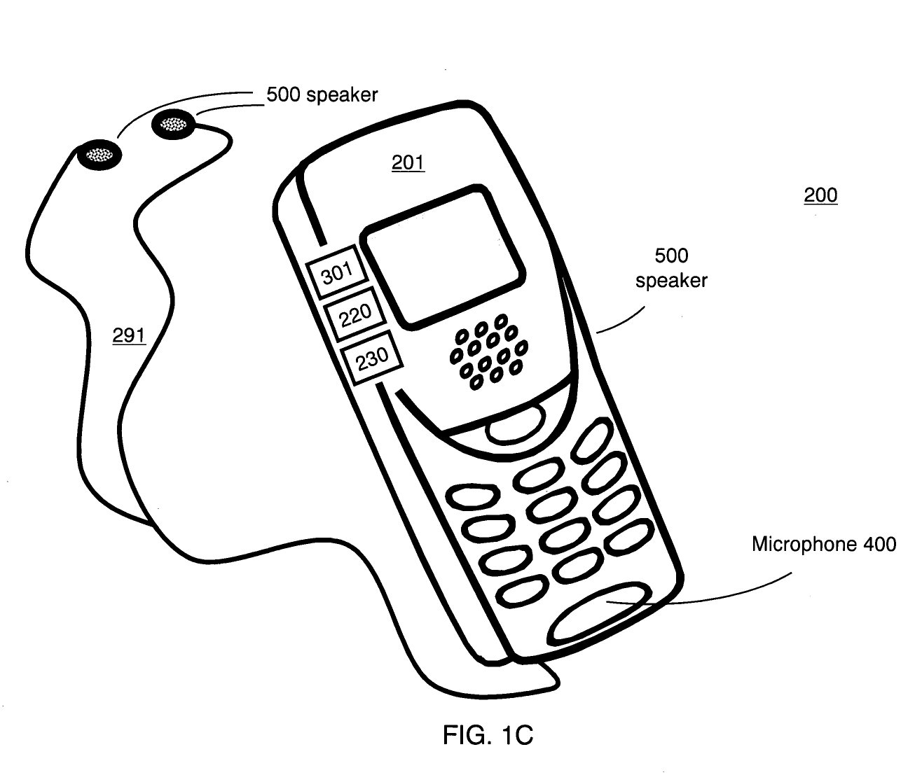

FIG. 1A illustrates sound system 200, according to an embodiment of the invention. Sound system 200 includes processor 220 is configured to receive one or more requested sound signal 110 (e.g. from at least one sound signal providing system 300) and at least one ambient sound input signal 120 (e.g. from one or more microphones 400).

Processor 220 is further configured to generate modified requested signal 130 by processing, in response to a desired level of ambient sound that is defined by a user, requested sound signal 110 and ambient sound input signal 120, wherein an inclusion level of the ambient sound input signal in the modified requested signal is responsive to the desired level of ambient sound.

It is noted that the user may define the desired level of ambient sound in various manners, according to different embodiments of the invention. For example, the user may use dedicated interface of sound system 200 and/or of sound signal providing system 300 (e.g. up/down buttons, sliders, etc), may use a selection menu of interface of sound system 200 and/or of sound signal providing system 300, may provide voice commands (e.g. using microphone 400), and so forth.

It is noted that processor 220 may implement digital signal processing schemes, analogue signal processing schemes, or any combination thereof, for the implementation of its different functionalities, some of which are discussed herein.

According to an embodiment of the invention, sound providing system 300 may be a part of system 200, but this is not necessarily so. Requested sound signal 110 is requested in that it is intended to be heard by a recipient of modified sound signal 130. Requested sound signal 110 may and may not be specifically requested for (e.g. selection of a song to be played, selecting to receive a telephone conversation, etc.). It is noted that, according to an embodiment of the invention, the intention to receive requested sound signal 110 may be expressed by connecting to sound providing system 300, by choosing to receive a type of sound signals or a group of sound signals (e.g. audio alarms), etc.

Likewise, according to an embodiment of the invention, microphone 400 may be a part of system 200, but this is not necessarily so. Microphone 400 may be, according to an embodiment of the invention, a dedicated microphone—dedicated to detect ambient sound signals to be at least partly included in modified sound signal 130 (and or at least partly canceled), but it is not necessarily so. Microphone 400 may also have other functionalities (e.g. a microphone of a smart phone) and may detect ambient sound input signal 120 as a secondary function, or as an additional function.

It is noted that according to an embodiment of the invention, multiple requested input signals 110 may be received and processed by processor 220—possibly also concurrently. For example, one or more sound signal providing systems 300 may provide a music stream from a music player, a telephone conversation sound from a telephony unit, and an alarm indicative of some emergency state (e.g. battery is low, another vehicle is in close proximity, etc.).

It is noted that in some situations the user may wish not to be exposed to ambient sound (or to be exposed in a minimal level), e.g. when the user is listening to music in home. In such situations the user may benefit from null inclusion level of ambient sound in modified sound signal 130, it is noted that in such situations and according to some embodiments of the invention, the user may further benefit form various sound cancellation techniques (either active or passive) that may be implemented in sound system 200, e.g. as disclosed below.

In other situations, such cut off from the external world may be undesired. In many situations a user listening to modified sound signal 130 does not wish to be totally unaware of ambient sound input signal 120. For example, a bicycle rider listening to music as requested signal requested input signal 110 may not want external traffic sound to be reduced too much, for security reasons. A technician repairing a system in an engines cabin may not want external machinery sounds reduced to maximum.

Therefore, processor 220 is configured to process requested input signal 110 and ambient sound input signal 120 to provide modified sound signal 130 in response to the desired level of ambient sound which is defined by a user. It is noted that, according to an embodiment of the invention, the processing may be further responsive to a user defined cancellation-parameter, that affects the level of active cancellation that may be applied to ambient sound input signal 120, in some embodiments of the invention.

The desired level of ambient sound defined by the user may take different forms in different embodiments of the invention. For example, a user defined parameter may define a minimum allowed volume of ambient noise provided, a maximum allowed volume of ambient noise provided, a reduction rate (e.g. in percents), a reduction level selected out of few provided options, a predetermined recipe (e.g. inclusion of only limited frequencies range), a recipe defined by the user, a ratio between the requested input signal 110 and ambient sound input signal 120, and so forth.

According to an embodiment of the invention, processor 220 may be configured to determine (or otherwise effect) the inclusion level of the ambient sound input signal 120 in the modified requested signal 130 based on: (1) the desired level selected by the user, and—according to some embodiments of the invention—also basing on (2) a state of ambient sound input signal 120 and/or a state of requested input signal 110.

It is noted that the inclusion level may be applied, according to different embodiments of the invention, to some or all of ambient sound input signal 120—e.g. it may include a percentage of inclusion attempt (e.g. 8% of original ambient sound input signal 120), include a maximal or minimal level of allowed ambient sound input signal 120, an inclusion of only a limited range of frequencies (and to what extents), and so forth. It is noted that processor 220 may take into account when determining the inclusion level other parameters as well (e.g. detection of noise in ambient sound input signal 120, a low battery level of system 200, etc.).

It is noted that conveniently processor 220 may be configured to modify the inclusion level from time to time. This may happen in response to a modification in the user defined desired level, in response to a modification in the state of one of requested input signal 110 and ambient sound input signal 120, or to other parameters (e.g. modification in processing requirements of other processes managed by processor 220).

After determining the inclusion level (or parameters affecting it), processor 220 is further configured to generate modified sound signal 130 by processing, in response to the desired level, requested input signal 110 and ambient sound input signal 120.

It is noted that in some embodiments of the invention, the user may modify the user defined desired level in different times. According to an embodiment of the invention, the user defined desired level of ambient sound is defined by a user or entity other then the one that listens to modified sound signal 130. By way of example, it may be defined by a supervisor or a parent of the listener, may be a standard determination in a factory or an airline, and so forth. According to an embodiment of the invention, the user defined desired level is set only by the listener.

According to an embodiment of the invention, the desired level defined by the user may be defined by a user of system 200 (e.g. using a user interface of system 200). According to an embodiment of the invention, desired level may be defined using a user interface of a system that is connected to system 200 (e.g. of sound signal providing system 300, or of a headset that transduces modified sound signal 130). According to an embodiment of the invention, the desired level may be defined remotely, e.g. by a wireless connection or by an internet connection.

According to an embodiment of the invention, processor 220 is further configured to modify the inclusion level of ambient sound input signal 120 in response to a detected state of ambient sound input signal 120 and/or of requested input signal 110.

According to an embodiment of the invention, processor 220 is further configured to modify the inclusion level of ambient sound input signal 120 in response to modification in the detected state of ambient sound input signal 120 and/or of requested input signal 110.

As will be demonstrated below, the inclusion level of ambient sound input signal 120 may be modified in various types of detected states (and/or modification of detected states)—according to various embodiments of the invention.

For example, the detected state may be detected by analysis of ambient sound input signal 120 (e.g. if ambient sound input signal 120 passes a predetermined threshold, if a predefined sound pattern is detected in ambient sound input signal 120, a conversation is detected, etc.). The detected may also be detected by detecting a modification in ambient sound input signal 120—e.g. a reception state (e.g. on/off) of a microphone 400 out of one or more microphones 400 is changed.

For example, the detected state may be detected by analysis of requested input signal 110 (e.g. if requested input signal 110 passes a predetermined threshold, if a predefined sound pattern is detected in requested input signal 110, etc.). The detected may also be detected by detecting a modification in requested input signal 110—e.g. a transmission state (e.g. on/off) of a sound signal providing system 300 out of one or more sound signal providing systems 300 is changed, if a conversation state is initiated in a cellular phone, etc.

According to an embodiment of the invention, the inclusion level of ambient sound input signal 120 in modified sound signal 130 may also be modified in response to a signal received from an external system. For example, if one or more systems 200 are used by employee in a factory or an organization, a remote system (e.g. in a control room) may choose to send a signal requesting change of the inclusion level (or of the desired level) of ambient sound input signals 120 of the one or more users, e.g. to increase the allowed level of some or all of requested input signal 110, and/or to decrease the allowed level of some or all of requested input signal 110 (e.g. of a limited range of frequencies of which).

It is noted that, according to an embodiment of the invention, the processor may also be adapted to change an inclusion level of ambient sound input signal 120 in modified sound signal 130 in response to a detected state of ambient sound input signal 120 and/or of requested input signal 110, in response to a signal from an external system, etc.

Sound system 200 further includes signal provider 230 that is configured to provide modified requested signal 130 (which is provided to it by processor 220) to at least one speaker 500. It is noted that in many embodiments of the invention, the modified requested signal 130 is provided to both speakers 500 of a headset that includes two speakers. It is noted that wherein “at least one speaker” is used, in some embodiments multiple speakers may be implemented (e.g. two speakers of a two-speakers headset, or two or more speakers—and possibly all speakers—of a headset that includes more than two speakers)

However, other embodiments may be implemented as well and may be useful in some situations. For example, in a firing range one ear of the user may be blocked, and only one ear may be used for receiving a modified sound signal 130 that includes requested input signal 110 of a communication network, and a low level of ambient sound input signal 120 inserted.

In another embodiment, the user may wish to receive some level of ambient sound input signal 120 only in one ear, wherein the other speaker provides regular requested input signal 110 sound.

According to an embodiment of the invention, the at least one speaker 500 is included in sound system 200. According to an embodiment of the invention, the at least one speaker 500 is included in one or more external system, that may receive information from sound system 200 over a wired or wireless connection, and/or a combination thereof.

It is noted that in some situations, one processor 220 identifies that the detected state of ambient sound input signal 120 and/or of requested input signal 110 ceased (e.g. no siren is identified any longer), the inclusion level of requested input signal 110 may be restored to its previous level. According to an embodiment of the invention, the inclusion level is restored only in response to user input.

According to an embodiment of the invention, speaker 500 is a speaker of a headset. A headset include one or more speakers (e.g. one or two, and possibly more), wherein at least some of those speakers are intended to be placed in close proximity to a aural sensory organ such as the ear (it is noted that other types of speakers such as bone conduction speakers may also be implemented). Such a headset may include mechanical means for securing such speakers in the proximity of the ear (or other organ), but this is not necessarily so. For example, according to an embodiment of the invention, a cellular phone which is placed in the vicinity of the ear may also serve as a headset.

FIG. 1B illustrates sound system 200 incorporated into a headset, according to an embodiment of the invention. It is noted that processor 220 and/or signal provider 230 may be incorporated into various components of the headset, in different embodiments of the invention.

It should be noted that sound system 200 may also be implemented in systems in which some or all of the speakers are not located in the vicinity of the ear. For example, sound system 200 may be incorporated in a car sound system, airplane sound system, factory sound system, etc. According to an embodiment of the invention, the microphone in such an embodiment may be located outside the car, airplane, etc., or the respective confined space (e.g. room, building).

It is noted that, according to an embodiment of the invention, ambient sound input signal 120 is picked up by a microphone that is located outside the ear, in vicinity to it (e.g. within a distance of under 7 centimeters from the our). However, this is not necessarily so. For example, a parent may want to include in modified sound signal 130 a signal detected by a microphone of a child sensor located in a cradle of his child.

According to an embodiment of the invention, processor 220 is further configured to analyze the ambient sound input signal 120 and to identify a predefined sound pattern in ambient sound input signal 120, wherein the processor is further configured to process the requested input signal 110 and ambient sound input signal 120 in response to the identified predefined sound pattern.

According to an embodiment of the invention, processor 220 is configured to determine the inclusion level of ambient sound input signal 120 in modified sound signal 130 in response to a detection of a predefined sound pattern in the ambient sound input signal, wherein the detection may and may not be carried out by processor 220.

In different embodiments, different predefined sound patterns may be implemented. For example, the predefined sound pattern may be related to emergency cases (siren of an ambulance, explosion, alarm), may be related to identification of human conversation, to mechanical malfunction (e.g. in a car), etc.

It is noted that the analysis of ambient sound input signal 120 may include digital and/or analog processing. It is noted that processor 220 may carry out different actions in response to a detection of the predefined sound pattern, and to process requested input signal 110 and ambient sound input signal 120 in different ways. For example, once the predefined sound pattern is detected, processor 200 may reduce a volume of the music (or other requested input signal requested input signal 110), thus enabling the listener to hear the external sound. According to an embodiment of the invention, processor 220 may indicate to the listener in such situation by a synthesized sound or in any other way that the predefined event associated with the predefined sound pattern occurs.

According to an embodiment of the invention, processor 220 is configured to reduce a volume of requested sound signal 110 (or a portion of it—e.g. a predetermined duration, or a limited range of frequencies) in modified requested signal 130 provided to the at least one speaker 500, in response to the identification of the predefined sound pattern. This may enable a clearer aural perception of ambient sound by the listener, e.g. in a case of emergency.

According to an embodiment of the invention, processor 220 is configured to increase/reduce the inclusion level of the ambient sound input signal in response to a detection of the predefined sound pattern.

According to an embodiment of the invention, processor 220 is configured to increase a volume of requested sound signal 110 (or a portion of it—e.g. a predetermined duration, or a limited range of frequencies) in modified requested signal 130 provided to the at least one speaker 500, in response to the identification of the predefined sound pattern. This may enable a clearer aural perception of desirable sound signals received from one or more out of the at least one sound signal providing system 300, e.g. if the requested input signal 110 includes instructions, or if a volume of requested input signal 110 raised above efficient processing level.

According to an embodiment of the invention, processor 220 is configured to otherwise process requested sound signal 110 (or a portion of it—e.g. a predetermined duration, or a limited range of frequencies) in modified requested signal 130 provided to the at least one speaker 500, in response to the identification of the predefined sound pattern.

According to an embodiment of the invention, processor 220 is further configured to increase an inclusion level of ambient sound input signal 120 (or a portion of it—e.g. a predetermined duration, or a limited range of frequencies) in modified sound signal 130 provided to the at least one speaker 500, in response to the identification of the predefined sound pattern. This may enable a clearer aural perception of ambient sound by the listener, e.g. in a case of emergency.

According to an embodiment of the invention, processor 220 is further configured to reduce an inclusion level of ambient sound input signal 120 (or a portion of it—e.g. a predetermined duration, or a limited range of frequencies) in modified sound signal 130 provided to the at least one speaker 500, in response to the identification of the predefined sound pattern. This may enable a clearer aural perception of desirable sound signals received from one or more out of the at least one sound signal providing system 300, e.g. if the requested input signal 110 includes instructions, or if a volume of requested input signal 110 raised above a predetermined threshold.

According to an embodiment of the invention, processor 220 is further configured to otherwise process ambient sound input signal 120 (or a portion of it—e.g. a predetermined duration, or a limited range of frequencies) in modified sound signal 130 provided to the at least one speaker 500, in response to the identification of the predefined sound pattern.

According to an embodiment of the invention, processor 220 is further configured to insert into modified sound signal 130 an indication about the detection of the predefined sound pattern. It is noted that the indication may be indicative of detection of the predefined sound pattern and/or on the type of the predefined sound pattern. According to an embodiment of the invention, processor 220 is further configured to insert into the modified requested signal an indication about a type of the predefined sound pattern.

For example, processor 220 may retrieve from a memory of sound system information for generation of a sound indication (e.g. a prolonged beep sound) or vocal indication (e.g. a recorded message indicating that there is a mechanical malfunction), and insert that indication into modified sound signal 130.

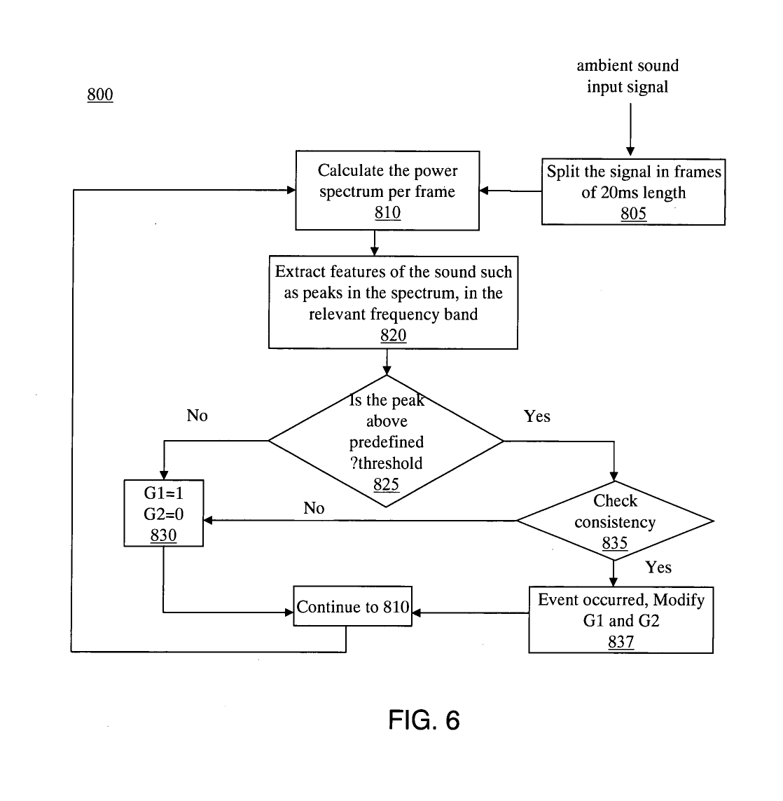

According to an embodiment of the invention, processor 220 is further configured to generate a power spectrum of the ambient sound input signal for multiple time frames (e.g. by analyzing by spectrum analysis multiple time frames of the ambient sound input signal to provide a power spectrum), and to process the power spectrums to detect peaks that exceeds a predetermined threshold for more than a predetermined period in at least one frequency associated with the predefined sound pattern. An example of such operation is exemplified in relation to FIG. 6.

According to an embodiment of the invention, processor 220 is further configured to detect the predefined sound pattern by generating a power spectrum of the ambient sound input signal for each time frame out of multiple time frames, and by processing the multiple power spectrums to detect peaks that exceeds a predetermined threshold for more than a predetermined period in at least one frequency associated with the predefined sound pattern.

According to an embodiment of the invention, processor 220 is further configured to determine parameters of the predefined sound pattern in response to user input received from the user. That is, the user (either the listener or another user, e.g. as exemplified above) may provide parameters, or indicate a recording and/or analysis of ambient sound input signal 120, from which a predefined sound pattern may be defined and later recognized. For example, a user may train processor 220 to identify when the RPM of the engine of a car exceeds 7000 RPM, and to stop any music played and increase the inclusion level of the ambient sound in such an event.

According to an embodiment of the invention, sound system 200 is included in a mobile communication device (denoted 201), such as a cellular phone or a PDA. For example, FIG. 1C illustrates sound system 200 incorporated into a cellular phone, according to an embodiment of the invention. It is noted that the mobile communication device 201 in its entirety may be considered, according to an embodiment of the invention, as sound system 200.

According to an embodiment of the invention, requested input signal 110 may be provided by a communication component 301 of mobile communication device 201 (wherein component 301 may thus serve as sound signal providing system) in response to a signal received over a wireless communication connection. For example, requested input signal 110 may include information of a voice conversation. It is noted that requested input signal 110 may also be received over other types of wireless communication—e.g. Bluetooth communication. It is noted that requested input signal 110 may be provided by other components of mobile communication device 201—e.g. from a music database of which.

According to an embodiment of the invention, ambient sound input signal 120 is detected by a microphone 400 of mobile communication system 201. Microphone 400 of mobile communication system 201 may also serve for detection of user speech signal, e.g. during telephone conversations, or memo recordings. According to an embodiment of the invention, signal provider 230 is configured to provide the modified requested signal 130 to at least one speaker 500 of mobile communication device 201, and/or to the speakers 500 of a headset 291 that is connected to mobile communication system 201. The one or more speakers 500 of mobile communication device 201 (or of a connected headset 291) may also serve for the provision of other sounds to the user.

According to an embodiment of the invention, processor 220 is further configured to determine an inclusion level of ambient sound input signal 120 that allows an inclusion of a desired level of user speech from ambient sound input signal 120 in modified sound signal 130.

It is known that in some cases during telephone conversations (e.g. in cases when the user speaks and his ears are blocked by a headset) the user does not hear himself properly, and due to the incorrect feedback the user might increase the level of the speaking, and as a result he might speak very loudly. Therefore, in such situations an increased level of inclusion of the ambient sound signal—that may enable inclusion of his voice in modified sound signal 130—may benefit the user.

According to an aspect of the invention, microphone 400 is used to pick the ambient noise as well as the user's speech, wherein processor 220 may then inject it, in a controllable manner, modified sound signal 130 and thus to speaker 500 (e.g. to the headset speakers). This may improve significantly the phone conversation experience when the two ears are blocked. It is noted that, according to an embodiment of the invention, techniques of separating between user speech and back ground noise may be implemented (e.g. using two or more microphones 400 in different distances from a mouth of the user).

According to an embodiment of the invention, processor 220 is further configured to reduce sound level of portions of the ambient sound input signal that do not comprise user speech. This may be carried out, by way of example, by filtering frequency ranges not used by human speech, or by other techniques of separating between user speech and back ground noise may be implemented (e.g. using two or more microphones 400 in different distances from a mouth of the user).

According to an embodiment of the invention, processor 220 is further configured to determine the inclusion level in response to a detected level of the user speech in the ambient sound input signal, wherein the detection of the level of the user speech may be implemented in different ways, e.g. using two or more microphones 400 in different distances from a mouth of the user

According to an embodiment of the invention, processor 220 is configured to determine the inclusion level of the user speech further in response to the desired level of ambient sound defined by the user.

As aforementioned, according to an embodiment of the invention, sound system 200 further includes microphone 400 and/or speaker 500.

Referring to the processing of requested input signal 110 and ambient sound input signal 120 by processor 220, it is noted that processor 220 may usually process at any given moment information of requested input signal 110 that refers to substantially the same time frame as the information acquired from ambient sound input signal 120. Sound information pertaining to the sound that should be provided in a given time from requested input signal 110 may be processed with information relating to substantially the same given time—and possibly a little bit before that. It is noted that, according to an embodiment of the invention, estimation techniques may be implemented by processor 220 for ambient sound input signal 120, in order to estimate its value in the given time.

As sound systems may generally be adapted to reduce ambient noise effect, and to provide clear sound of requested input signal 110, processor 220 may be further configured, according to an embodiment of the invention, to process sound signals 110 and 120 by superimposing a cancellation signal for reducing a level of ambient sound input signal 120 onto requested input signal 110. The cancellation signal for example may be an anti-phase signal having an opposite phase to that of the ambient sound input signal. It is noted that processor 220 may implement other types of active noise cancellation. It is further noted that other types of noise control may be implemented—either by system 200, or by another system (e.g. a headset connected to system 200 which provides modified requested signal 130 to a user, an external isolation system, etc.).

Some of the additional techniques that may be implemented may be, by way of example, sound insulation techniques (that prevent the transmission of noise by the introduction of a mass barrier), sound absorption techniques (in which a porous material that acts as a ‘noise sponge’ converts the sound energy into heat within the material), vibration damping techniques (in which vibration energy is extracted as dissipated as heat), and vibration isolation techniques (in which transmission of vibration energy from a source to a receiver is prevented by introducing a flexible element or a physical break).

The user defined cancellation may take different forms in different embodiments of the invention. For example, user defined cancellation-parameter may define a minimum allowed volume of ambient noise provided, a maximum allowed volume of ambient noise provided, a reduction rate (e.g. in percents), a reduction level selected out of few provided options, selection of cancellation frequencies (and cancellation levels for which), a predetermined recipe (e.g. engine noise reduction), a recipe defined by the user, and so forth.

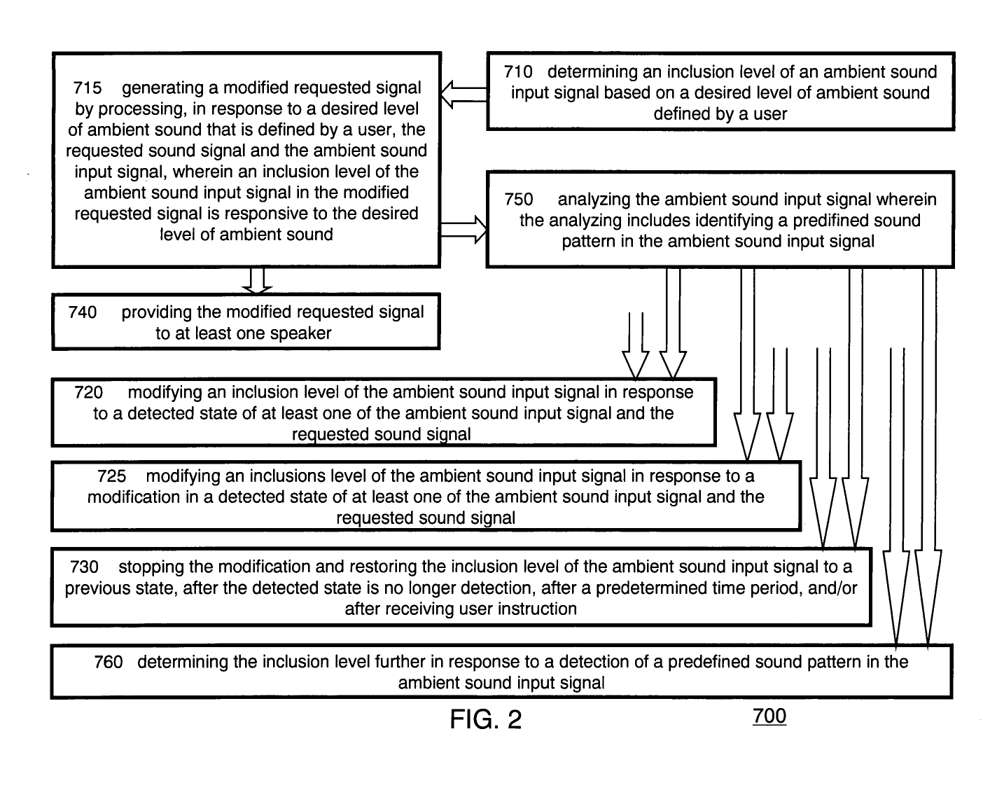

FIG. 2 illustrates method 700 for providing a sound signal, according to an embodiment of the invention. Referring to the examples set forth in the previous drawings, method 700 may be carried out by a sound system such as sound system 200. It is noted that various embodiments of method 700 may implement the various functionalities disclosed with relation to sound system 200 and or the other sound systems disclosed, even if not explicitly elaborated so.

Method 700 may include stage 710 of determining an inclusion level of an ambient sound input signal in a modified sound signal, based on a desired level defined by a user. The determining may be further responsive, according to an embodiment of the invention, to a state of at least one of the ambient sound input signal and a requested sound signal.

Referring to the examples set forth in the previous drawings, stage 710 may be carried out by processor 220.

Method 700 includes stage 715 of generating a modified requested signal by processing, in response to a desired level of ambient sound that is defined by a user, the requested sound signal and the ambient sound input signal, wherein an inclusion level of the ambient sound input signal in the modified requested signal is responsive to the desired level of ambient sound;

Referring to the examples set forth in the previous drawings, stage 715 may be carried out by processor 220.

According to an embodiment of the invention, method 700 may further include stage 720 of modifying the inclusion level of the ambient sound input signal in response to a detected state of at least one of the ambient sound input signal and the requested sound signal. Referring to the examples set forth in the previous drawings, stage 720 may be carried out by processor 220.

According to an embodiment of the invention, method 700 may further include modifying a cancellation level of the ambient sound input signal in response to a detected state of at least one of the ambient sound input signal and the requested sound signal. Referring to the examples set forth in the previous drawings, stage 720 may be carried out by processor 220.

According to an embodiment of the invention, method 700 further includes stage 725 of modifying an inclusion level of the ambient sound input signal in response to a modification in a detected state of at least one of the ambient sound input signal and the requested sound signal. Referring to the examples set forth in the previous drawings, stage 725 may be carried out by processor 220.

It is noted that, according to an embodiment of the invention, method 700 may further include stage 730 of stopping the modification and restoring the inclusion level of the ambient sound input signal to a previous state, after the detected state is no longer detected, after a predetermined time period, and/or after receiving user instruction. Referring to the examples set forth in the previous drawings, stage 730 may be carried out by processor 220.

Method 700 further includes stage 740 of providing the modified requested signal to at least one speaker, wherein—according to an embodiment of the invention the speaker is a speaker of a headset. Referring to the examples set forth in the previous drawings, stage 740 may be carried out by signal provider 230.

According to an embodiment of the invention, the determining includes stage 760 of determining the inclusion level further in response to a detection of a predefined sound pattern in the ambient sound input signal. Stage 760 may be carried out following stage 750 (discussed below), but this is not necessarily so. Referring to the examples set forth in the previous drawings, stage 760 may be carried out by processor 220.

According to an embodiment of the invention, method 700 further includes stage 750 of analyzing the ambient sound input signal wherein the analyzing includes identifying a predefined sound pattern in the ambient sound input signal. According to an embodiment of the invention, the processing is responsive to the identified predefined sound pattern. Referring to the examples set forth in the previous drawings, stage 750 may be carried out by processor 220. According to various embodiment of the invention, various actions relating to the processing of the requested input signal and or the ambient sound input signal may be carried out (as well as potentially other actions).

According to an embodiment of the invention, the processing includes reducing a volume of at least a portion of the requested sound signal in the modified requested signal provided to the at least one speaker. According to an embodiment of the invention, the processing includes increasing the volume of at least a portion of the requested sound signal in the modified requested signal provided to the at least one speaker. According to an embodiment of the invention, the processing includes otherwise processing the requested sound signal in the modified requested signal provided to the at least one speaker.

According to an embodiment of the invention, the processing includes reducing, increasing, or otherwise processing or modifying an inclusion level of at least a portion of the ambient sound input signal in the modified requested signal provided to the at least one speaker.

According to various embodiments of the invention, method 700 may include reducing, increasing, or otherwise modifying the inclusion level of the ambient sound input signal in response to a detection of the predefined sound pattern.

According to an embodiment of the invention, the processing includes inserting into the modified requested signal an indication about the detection of the predefined sound pattern. It is noted that the indication may be indicative of detection of the predefined sound pattern and/or on the type of the predefined sound pattern. According to an embodiment of the invention, the processing includes inserting into the modified requested signal an indication about a type of the predefined sound pattern.

According to an embodiment of the invention, method 700 further includes determining, prior to the analyzing, parameters of the predefined sound pattern in response to user input received from the user.

According to an embodiment of the invention, the analyzing includes generating a power spectrum of the ambient sound input signal for multiple time frames (e.g. analyzing by spectrum analysis multiple time frames of the ambient sound input signal to provide a power spectrum), and processing the power spectrums to detect peaks that exceeds a predetermined threshold for more than a predetermined period in at least one frequency associated with the predefined sound pattern.

According to an embodiment of the invention, method 700 further includes detecting the predefined sound pattern by generating a power spectrum of the ambient sound input signal for each time frame out of multiple time frames, and by processing the multiple power spectrums to detect peaks that exceeds a predetermined threshold for more than a predetermined period in at least one frequency associated with the predefined sound pattern.

According to an embodiment of the invention, the processing is carried out by a processor of a mobile communication device and includes processing the requested input signal, that is provided by a communication component of the mobile communication device in response to a signal received over a wireless communication connection, and the ambient sound input signal that is detected by a microphone of the mobile communication system. According to an embodiment of the invention, the processing further includes determining an inclusion level of the ambient sound input signal that allows an inclusion of a desired level of user speech from the ambient sound input signal in the modified requested signal. According to an embodiment of the invention, the providing includes providing the modified requested signal to at least one speaker of the mobile communication device.

According to an embodiment of the invention, the processing includes reducing sound level of portions of the ambient sound input signal that do not include user speech.

According to an embodiment of the invention, the determining of the inclusion level is responsive to a detected level of the user speech in the ambient sound input signal.

According to an embodiment of the invention, the determining of the inclusion level is responsive to the user defined desired level and/or to another user defined level indicating parameter.

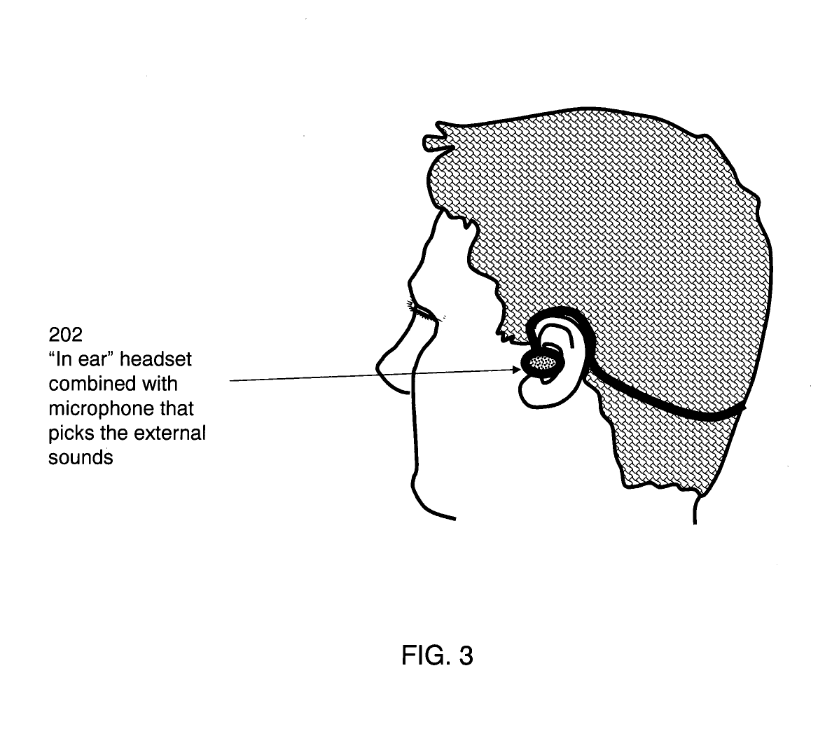

FIG. 3 illustrates sound system 202 (which is an embodiment of sound system 200), according to an embodiment of the invention. Sound system 202 is incorporated into a headset, e.g. as disclosed above. Sound system 202 includes a headset microphone 400 (not illustrated in FIG. 3) that picks up ambient sound. Processor 220 of sound system 202 (not illustrated in FIG. 3) injects ambient sound input signal 120 into the speakers of the headset in a controllable volume, where the user can control the amount of external sound he is willing to hear simultaneously with requested input signal 110 (e.g. simultaneously with music).

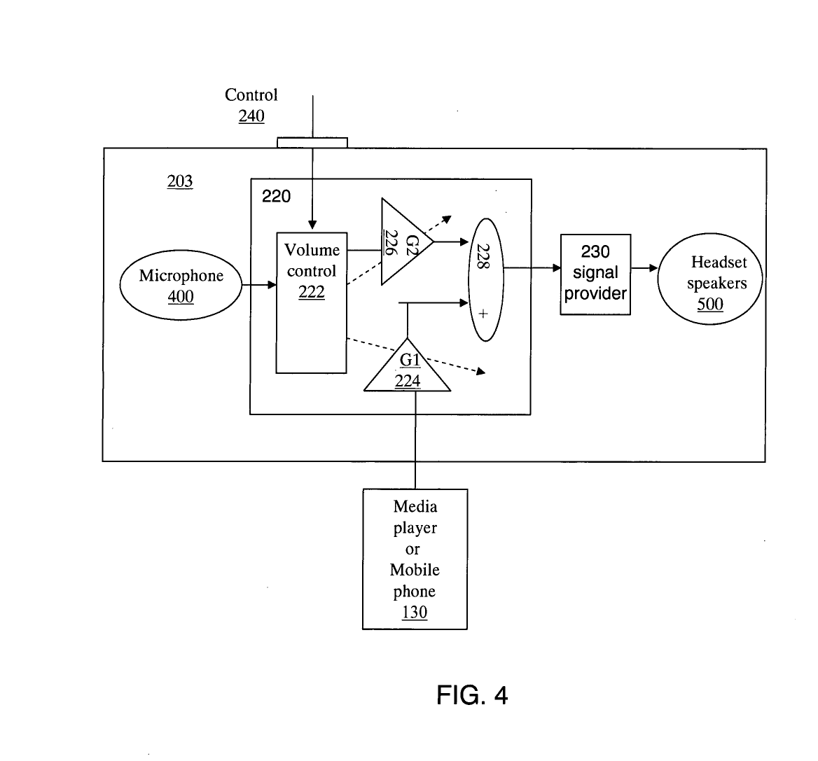

FIG. 4 illustrates sound system 203 (that is an embodiment of sound system 200), according to an embodiment of the invention. It is noted that sound system 203 may be incorporated into a mobile device, such as a cellular phone, a music player, a PDA, etc.

Today many mobile phones provide headset that consist of two speakers and a microphone. The two speakers may be used for listening to stereo music as well as to listening to incoming speech during the phone call. The microphone may be used to send the user's speech to the far end user. In cases that the user speaks and his ears are blocked by the headset, he does not hear himself correctly, hence due to the incorrect feedback he might increase the level of the sound that he speaks and as a result he might speak very loudly.

According to an aspect of the invention, a microphone 400 of sound system 203—that may be a mobile communication device—is integrated in a mobile phone (or other mobile communication device e.g. PDA). Microphone 400 may be used to pick the ambient noise and the user's speech (both as one or more ambient sound input signals 120) and processor 220 may then inject it (possibly after some processing) in a controllable manner to the headset speakers 500 (via signal provider 230). Such an implementation may significantly improve the phone conversation experience, e.g. when the two ears are blocked.

Sound system 203 may include a control 240, where the user can control the amount of music and ambient sound he wants to hear simultaneously. The control may be carried out in various manners, in various embodiments of the invention.

For example, the user may use the control 240 to defined a minimum allowed volume of ambient noise provided, a maximum allowed volume of ambient noise provided, a reduction rate (e.g. in percents), a reduction level selected out of few provided options, selection of inclusion frequencies (and inclusion level for which), a predetermined recipe (e.g. engine noise reduction), a recipe defined by the user, and so forth.

Microphone 400 collects ambient sound input signal 120 that is fed to processor 220 (e.g. to volume control component 222). Based on the user defined desired level of ambient sound (that may be received via control 240), processor 220 modifies a gain of requested input signal 110 produced by media player 130 (acting as system 300) and modifies ambient sound input signal 120 produced by microphone 400—e.g. by reversing a phase of ambient sound input signal 120 and by modifying a gain of ambient sound input signal 120. It is noted that those signals may be otherwise modified. According to an embodiment of the invention, the two modified signals are added by processor 220, and are fed by signal provider 230 to the headset speakers 500. The modification of the gain of requested input signal 110 may be carried out by amplifier/gain modifier/processor 224 (denoted G1). The modification of the gain of ambient sound input signal 120 may be carried out by amplifier/gain modifier/processor 226 (denoted G2). The adding/summing of the modified signal may be implemented, according to an embodiment of the invention, by adder 228.

For example, according to an embodiment of the invention, in a case that the user does not want to listen to the ambient sound, volume control unit 222 may choose G2=0 and G1=1 (in the notation used, G2=0 means null inclusion of ambient sound input signal 120, and possibly also maximal cancellation of it, if cancellation is implemented). In cases where the user wants to hear some ambient sound, G1 is changed to reduce the volume of the sound produced by system 300 (here denoted 130) and the sound received from microphone 400 is increased by G2.

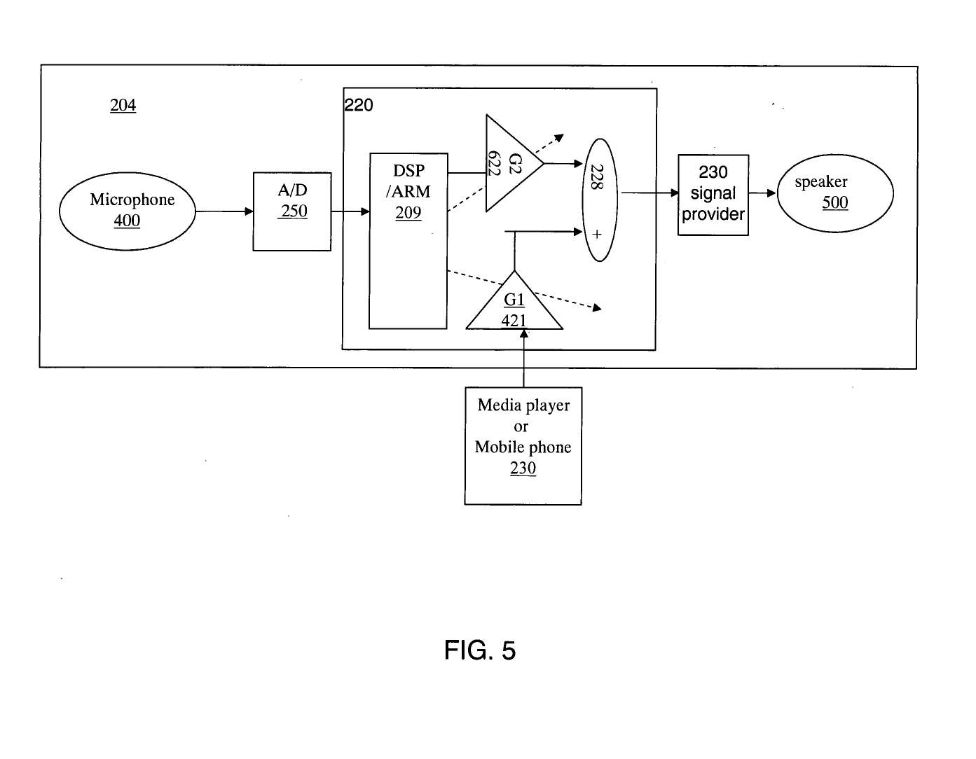

FIG. 5 illustrates sound system 204 (that is an embodiment of sound system 200), according to an embodiment of the invention. Sound system 204 may be incorporated into a headset, but this is not necessarily so. Microphone 400 of sound system 204 collects the ambient sound (as ambient sound input signal 120) and processor 220 analyzes it by a DSP. According to an embodiment of the invention, microphone 400 may be implemented as one or multi channel microphones, it can be of a common type of microphone (e.g. a condenser microphone), but this is not necessarily so.

Processor 220 may be configured to check whether a predefined event occurred during the time that the user is listening to the music.

Ambient sound input signal 120 collected by microphone 400 may be digitized by analog to digital 250 (that may be incorporated into processor 220, and may be incorporated into microphone 400). The digitized sound is fed to processor 220 (e.g. to a DSP or ARM component 209 of which). Based on the DSP results, processor 220 may modify requested input signal 110 produced by the sound signal providing system 300 (also denoted media player 230) and ambient sound input signal 120 (e.g. by modifying a gain of which). The two sound signals may than be added up and then provided by signal provider 230 to one or more speakers 500.

According to an embodiment of the invention, in a case that no event occurred, G2=0 and G1=1. In cases where a predefined event is detected, G1 may be changed to reduce the volume of requested input signal 110 and the ambient sound input signal 120 may be increased by G2.

According to an embodiment of the invention, a predefined message that is generated by DSP 209 may be injected to the speaker 500. According to an embodiment of the invention, once the predefined event is over the gains are set that the user will continue to listen to the music as usual. Some examples of the process are illustrated in FIG. 6.

FIG. 6 illustrates a flowchart of method 800 for modifying an inclusion level of the ambient sound input signal in response to a detected state of at least one of the ambient sound input signal and the requested sound signal, according to an embodiment of the invention.

It is noted that the process illustrated in FIG. 6 is exemplified where the predefined event is an ambulance siren, and that other—more complex—embodiments may be implemented. This example is provided to demonstrate the flexibility of the apparatus however different events can be also detected with the same apparatus by changing the DSP process.

In stage 805 of method 800, the ambient sound input signal (either digitized or not) is divided into frames, where the size of the frame may be, by way of example, 20 ms.

Stage 810 includes applying spectrum analysis to each of the frames (or to a subgroup of frames, e.g. every third frame), and calculating its power spectrum. According to an embodiment of the invention, the power spectrum can be calculated by the DSP using FFT.

Following stage 810 of calculation of the power spectrum, stage 820 includes searching for features of the sound signals such as peaks in the range of frequencies that we can expect to find Ambulance siren (or other predefined sound pattern).

Stag 825 includes determining if a peak (e.g. the highest peak in a region of peaks) exceeds a predetermined threshold.

If the peak is lower than the threshold, denoted 830, it may be assumed that there is no siren in this area and the processing may be carried out as determined using the user defined inclusion level (e.g. G1=1, G2=0, namely no change in gain of the music).

If the peak is above the threshold, stage 835 may be carried out, that includes continue to check for consistency in the exceeding of the threshold. It is noted that according to an embodiment of the invention stage 835 may be skipped, and instead stage 837 may be carried out directly. By way of example, a simple consistency check as implemented in stage 835 may include determining whether the period of the siren is long enough. If it fails we assume no siren in our neighborhood, and stage 830 may be carried out. Otherwise we assume that there is a siren and stage 837 may be carried out, that includes reducing (or otherwise modifying) a volume of the requested sound signal in the modified requested signal, and/or increasing (or otherwise modifying) an inclusion level of the ambient sound input signal in the modified requested signal. For example, G1 and G2 may be modified.

By returning to stages 810, 820 and 830 (e.g. on a frame by frame basis) during all the session that the user listens to the music, the user defined inclusion level may be resumed once the predefined sound pattern ceases.

It is obviously clear to a person who is skilled in the art that methods which are suitable for the operation of the systems disclosed above which differ from the method illustrated in flow chart 800 are also included in the scope of the invention.

Additionally, all of those methods could be incorporated into computer readable codes which could be stored in computer readable mediums, which can upgrade specially designed mobile devices and headsets, or upgrade existing mobile devices and/or headsets to operate according to the different embodiments of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A sound system, the sound system comprising:
a processor, configured to: (a) receive a requested sound signal and an ambient sound input signal; and (b) generate a modified requested signal by processing, in response to a desired level of ambient sound that is defined by a user, the requested sound signal and the ambient sound input signal, wherein an inclusion level of the ambient sound input signal in the modified requested signal is responsive to the desired level of ambient sound; and
a signal provider configured to provide the modified requested signal to multiple speakers of a headset.

2. The sound system according to claim 1, wherein the processor is further configured to modify the inclusion level of the ambient sound input signal in the modified requested signal in response to a modification in the detected state of at least one of the ambient sound input signal and the requested sound signal.

3. The sound system according to claim 1, wherein the processor is configured to determine the inclusion level of the ambient sound input signal in the modified requested signal in response to a detection of a predefined sound pattern in the ambient sound input signal.

4. The sound system according to claim 3, wherein the processor is configured to increase the inclusion level of the ambient sound input signal in the modified requested signal in response to a detection of the predefined sound pattern.

5. The sound system according to claim 3, wherein the processor is further configured to insert into the modified requested signal an indication about the detection of the predefined sound pattern.

6. The sound system according to claim 3, wherein the processor is further configured to insert into the modified requested signal an indication about a type of the predefined sound pattern.

7. The sound system according to claim 3, wherein the processor is further configured to detect the predefined sound pattern by generating a power spectrum of the ambient sound input signal for each time frame out of multiple time frames, and by processing the multiple power spectrums to detect peaks that exceeds a predetermined threshold for more than a predetermined period in at least one frequency associated with the predefined sound pattern.

8. The sound system according to claim 3, wherein the processor is further configured to determine parameters of the predefined sound pattern in response to user input received from the user.

9. The sound system according to claim 1, wherein the sound system is included in a mobile communication device, wherein the requested input signal is provided by a communication component of the mobile communication device in response to a signal received over a wireless communication connection; wherein the ambient sound input signal is detected by a microphone of the mobile communication system; wherein the processor is further configured to determine the inclusion level of the ambient sound input signal in the modified requested signal that allows an inclusion of a desired level of user speech from the ambient sound input signal in the modified requested signal.

10. The sound system according to claim 9, wherein the processor is further configured to determine the inclusion level of the ambient sound input signal in the modified requested signal in response to a detected level of the user speech in the ambient sound input signal.

11. The sound system according to claim 1, wherein the inclusion level of the ambient sound input signal in the modified requested signal is responsive to the desired level of ambient sound defined by a supervisor user that defines at least one desired level of ambient sound for multiple listeners.

12. The sound system according to claim 1, further comprising the microphone and the speaker.

13. A method for providing a sound signal, the method comprising:
receiving a requested sound signal and an ambient sound input signal;
generating a modified requested signal by processing, in response to a desired level of ambient sound that is defined by a user, the requested sound signal and the ambient sound input signal, wherein an inclusion level of the ambient sound input signal in the modified requested signal is responsive to the desired level of ambient sound; and
providing the modified requested signal to at least one speaker of a headset.

14. The method according to claim 13, wherein the processing further comprises modifying the inclusion level of the ambient sound input signal in the modified requested signal in response to a modification in a detected state of at least one of the ambient sound input signal and the requested sound signal.

15. The method according to claim 13, wherein the determining comprises determining the inclusion level of the ambient sound input signal in the modified requested signal further in response to a detection of a predefined sound pattern in the ambient sound input signal.

16. The method according to claim 15, wherein the processing comprises increasing the inclusion level of the ambient sound input signal in the modified requested signal in response to a detection of the predefined sound pattern

17. The method according to claim 15, wherein the processing comprises inserting into the modified requested signal an indication about the detection of the predefined sound pattern.

18. The method according to claim 15, wherein the processing comprises inserting into the modified requested signal an indication about a type of the predefined sound pattern.

19. The method according to claim 15, further comprising determining, prior to the analyzing, parameters of the predefined sound pattern in response to user input received from the user.

20. The method according to claim 15, further comprising detecting the predefined sound pattern by generating a power spectrum of the ambient sound input signal for each time frame out of multiple time frames, and by processing the multiple power spectrums to detect peaks that exceeds a predetermined threshold for more than a predetermined period in at least one frequency associated with the predefined sound pattern.

21. The method according to claim 13, wherein the processing is carried out by a processor of a mobile communication device and comprises processing the requested input signal, that is provided by a communication component of the mobile communication device in response to a signal received over a wireless communication connection, and the ambient sound input signal that is detected by a microphone of the mobile communication system; wherein the processing further comprises determining the inclusion level of the ambient sound input signal in the modified requested signal that allows an inclusion of a desired level of user speech from the ambient sound input signal in the modified requested signal; wherein the providing comprises providing the modified requested signal to at least one speaker of the mobile communication device.

22. The method according to claim 21, wherein the processing comprises reducing sound level of portions of the ambient sound input signal that do not comprise user speech.

23. The method according to claim 21, wherein the determining of the cancellation level is responsive to a detected level of the user speech in the ambient sound input signal.
